(19) United States
(12) Patent Application Publication
(10) Pub. No.: US 2007/0169399 A1
(43) Pub. Date: Jul. 26, 2007

(54) Fish hook and method of attaching to fishing tackle

(76) Inventors: Robert More, Montreal (CA); Marc Currie, Montreal (CA)

Correspondence Address: Mila Shvartsman, P.O. Box 48652, Outremont, H2V 4T9, omitted

(21) Appl. No.: 11/640,882

(22) Filed: Dec. 19, 2006

Related U.S. Application Data
(60) Provisional application No. 60/760,413, filed on Jan. 20, 2006.

(51) Int. Cl. A01K 83/00

(52) U.S. Cl. 43/44.83; 43/43.16; 43/44.82; 43/42.36

(57) ABSTRACT

The present invention relates to a fishing hook with a shank portion and at least one hook portion. The hook portion extends from a lower end of the shank portion, which is provided with a hook attachment element. The hook attachment element is adapted to be threaded onto a hook support element attached to fishing tackle. The hook attachment element facilitates free sliding of the fishing hook along the hook support element and the hook attachment element accommodates the hook support element in a substantially parallel relationship to the shank portion. The hook attachment element is a channel formed along the shank portion. This channel is formed within a tube extending along the shank portion, the tube being adapted to accommodate the hook support element within the channel. The tube can extend along the entire length of the shank portion, or at least ¼ of the length of the shank portion. The hook attachment element can also be a number of rings provided to accommodate the hook support element.

This application is based on a provisional patent application number U.S. 60/760,413.

The present invention relates to fish hooks, and more particularly to an improved fish hook and method of attaching a fish hook to a fishing line, lure, leader or other fishing tackle.

There is known U.S. Pat. No. 5,524,385 to Vincent Longo describing a fish hook comprising a hollow tubular member attached to a fish hook which is positioned near the shank head. Fishing line is secured to the hook shank by threading the line through the tube and knotting the line about the shank. In this patent, the fish hook does not slide along the line since the line is immovably knotted around the shank portion.

There is known U.S. Ser. No. 5,845,429 describing a fish hook with a hollow shaft, but the line is attached to said hook through the eye located near head of said hook.

There is also known U.S. Pat. No. 4,841,666 to Gust Dallas describing a releasable fish hook comprising a stem member suspended from the distal end of fishing line, a hook member and an anchoring assembly for releasable securing the hook member to the stem.

For decades, fishing hooks have been designed with one thing in common, the “Eye”. The eye of the hook is the closed loop at the top of any traditional hook design. No matter what the size, shape or number of hook elements (single, double, treble, quadruple, etc.), fishing hooks have been designed to be attached to fishing gear such as fishing lines, lures, leaders, lure wires, strings or other elements, using the “eye” as the point of attachment.

One of the problems with such traditional method of attachment occurs when making lures. Lure makers cannot easily attach a traditional hook to the middle or any spot on the lure wire other than the end of the lure even though, in many cases, predator fish tend to bite at the belly of their prey, or what would be the middle portion of the lure. There are methods of attaching inner hooks that involve wire harnesses, clevises, split rings, etc. The lure is prepared in sections. However, these are beyond the ability of the average fisherman to make. The current invention is simple and can be employed by anyone of average skill to make their own lures.

Traditional hooks placed in the middle or along the length of the lure disrupt the lure's water dynamics. Lures are made to be symmetrical and the spinners that are often included in their design do just what their name suggests: they spin around the lure's central assembly frame as they are most often attached by clevises. In doing so, the spinners follow a circular pattern around the lure that moves through water, but that does not hinder the lure's overall symmetry. Different color beads and other items are also used to attract a fish's attention and to separate all items on the lure assembly. As the lure is pulled through the water, each part of its assembly contributes to and does not disrupt its swim or the way it moves through the water. The problem with placing a traditional hook along the lure's length is the disruption of the lure's swim, its balance, and therefore a traditional hook in the middle of the lure, for example, ruins the whole purpose of the lure since the lure in its entity is supposed to look like a naturally-swimming small fish or other edible form of life.

Another problem occurs when a fish strikes the middle of a lure whose hooks are at its distal ends: the fish can be badly injured moments after striking. Their eyes or other parts of their body get caught on the distal hooks. Many fishermen follow a “catch and release” policy, wherein it is important to allow minimal damage to a fish that is to be released. If the fish is injured beyond healing, it will eventually die. If a fish is hooked in the mouth, it has much better chances of survival after release.

The third problem associated with traditional hooks is due to the fact that it is attached through the eye; it turns with the line and eventually causes “line twist”. Line twist is problematic for fisherman since it tangles the line and renders the line unusable. The only solution is to cut away the damaged line and re-attach the hook, which is a very annoying and time-consuming operation, and causes monofilament pollution. Sea life (seagulls, pelicans, etc.) gets tangled in discarded monofilament and eventually succumbs to starvation or dismemberment.

The fish hook of the present invention helps to solve the above problems and opens numerous possibilities to the fishing industry, lure makers, and fishing hobbyists. There are potentially thousands of new lure designs that can be built using this new hook design.

### OBJECT OF THE PRESENT INVENTION

The hook of the present invention comprises a shank which is threadable on the line, leader or lure's stem due to the presence of threadable means formed substantially along the length of the shank. This principle of presence of threadable means could be applied to any hook at the manufacturing level or used with any hook already available. The fishing hook of the present invention does not have a traditional eye as a method of attachment. Instead, such hook is threaded on the line or lure by means of a channel, tube or loops that are formed alongside of the hook's shank substantially through the length of the shank or right in between a multi hook assembly via a channel formed within the shank's portion of such assembly.

The hook of the present invention may be placed anywhere on a line, lure, leader or string while maintaining a symmetry. A hook threaded along its shank's portion will reduce line twist and help the lure stay symmetrical while spinning properly no matter where the hook is attached.

### BRIEF DESCRIPTION OF THE DRAWINGS

FIG. 1 shows a perspective view of the present invention depicting a treble hook assembly.

FIG. 2 shows a perspective view of a quadruple hook assembly.

FIG. 3 is a top view of FIG. 1

FIG. 4 is a cross-sectional view of FIG. 1.

FIG. 5 is a cross-sectional view of a single hook embodiment.

FIG. 6 is a cross-sectional view of the single hook variation of FIG. 5.

FIG. 7 is a cross-sectional view of the single hook embodiment with two attachment elements.

FIG. 8 is a cross-sectional view of the single hook having a number of attachment elements.

FIG. 9 shows a leader used with the present invention.

FIG. 10 shows a perspective view of the lure assembly incorporating hooks of the present invention.

### DETAILED DESCRIPTION OF THE PREFERRED EMBODIMENTS.

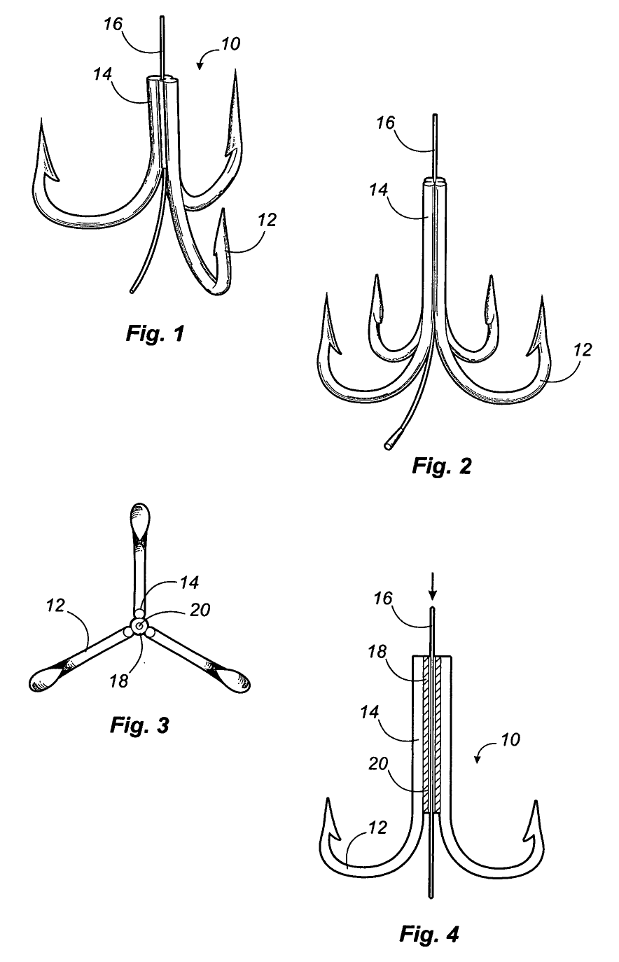

Referring to drawings, FIG. 1 shows a treble assembly 10 of the present invention comprising three identical hooks having shank portions 14 and hook portions 12. This treble hook comprises a hook attachment means, such as a channel or a tube 18 running along the entire length of shank portion 14 (FIG. 4) having a hollow space 20 provided to thread hook 10 onto fishing tackle such as line, lure's shaft, leader or any other line.

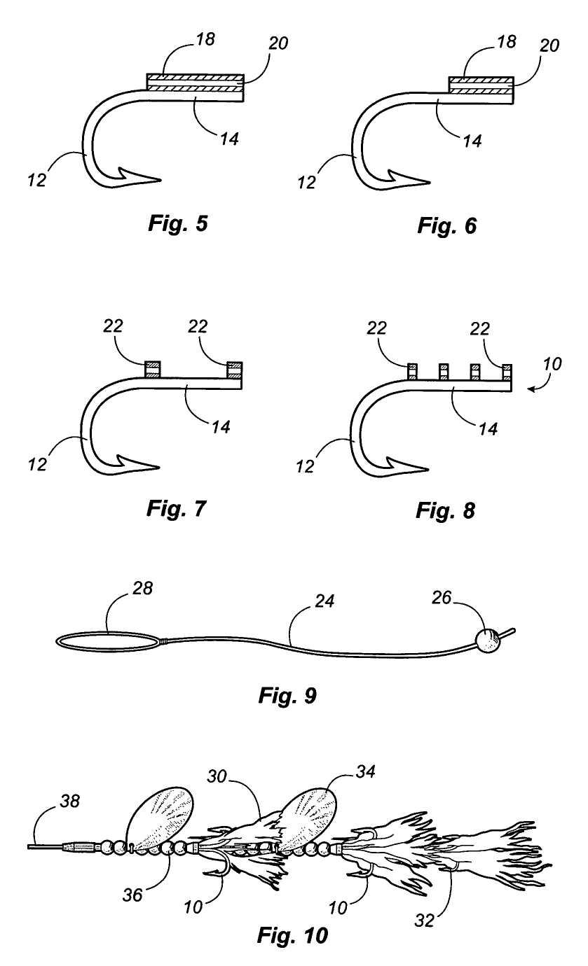

FIGS. 5 and 6 show another modification of the present invention comprising a single hook having a shank portion 14 and hook portion 12. Tube or channel 18 is formed along the length of the single hook and has also a hollow space 20 used in the same manner as embodiment of FIG. 1. The only difference between embodiments of FIG. 5 and 6 is the length of the channel 18. On FIG. 6, the channel 18 is not running through the entire length of the shank portion 14, but at least ¼ of the entire length of said shank portion. However, the difference between those two embodiments is insubstantial, because a shorter shaft does the same job. The most important factor is that the hook is not tied to the line, but threaded onto it. Tube 18 could be located at any position along the shank portion 14. Tube 18 can be attached to shank portion 14 via welding, soldering, brazing, forging and any other adhesive such as epoxy or glue.

FIGS. 7 and 8 show another modification of the present invention wherein instead of channel 18 there are a number of attachment elements 22 mounted along the shank portion 14. On FIG. 7 there are shown two of such elements mounted at the head portion and the end portions of the shank portion14. On FIG. 8 there are shown a number of elements 22 spaced apart along shank portion 14. The result in use is the same as for embodiments of FIGS. 5 and 6. In both cases shown on FIGS. 7 and 8, the hook is not tied to the line: it is threaded.

FIG. 9 shows a new design of the wire leader 24 specially provided for the present invention. One end of leader 24 comprises a flexible loop 28 and another end has a stopper 26, the diameter of which is larger than the diameter of the channel 20 of the hook 10. To assemble the tackle, the hook 10 is treaded on the leader 24 by means of flexible loop 28 adapted to effortlessly go through the channel 20. Stopper 26 is adapted to securely hold the hook 10 on the line since the diameter of channel 20 is smaller than the diameter of the stopper 26. However, the present invention is not restricted to present embodiment and any other similar means could be used. For example: the leader 24 could have loops at each end and a small weight may be crimped to one end (not shown) for the same purpose as stopper 26.

It must be emphasized that the channel or attachment elements as shown above are not necessary to be extending throughout the entire length of the shank portion of the hook. It is sufficient if those elements extend at least ¼ of the entire length of the shank to fulfill the purpose of the present invention.

The present invention can be made in many other different ways, such as if the channel is formed within the body of the shank itself. The most important part of the invention is that such hook is threaded on the line running alongside and parallel to the entire length of the shank portion.

In the case of a double hook assembly (not shown), the channel or tube may be formed in the weld connecting the shank portions of the individual hooks. Similar arrangement can be made in treble, quadruple or any other number of hooks welded together.

Design of the present invention can be used for any shape and/or size of hooks, any method of manufacturing, and any material used to manufacture the hooks.

FIG. 10 shows a lure assembly incorporating a few hooks 10 of the present invention wherein the lure wire 38 with the loop and the weight incorporates a number of beads 36, two hooks 10, spinners 34, deer tail 30 and a standard treble hook 32. It must be emphasized that any other combination of elements could be used instead of one shown on FIG. 10.

Due to the unique design of the present invention, the lure assembly facilitates a symmetrical way of producing hook assembly that can be attached lengthwise in parallel to the hook's shanks to any wire, shaft, line, leader or string, which is a great advantage of the present invention.

The hook assembly of the present invention can be placed anywhere on a lure, wire, shaft, line leader or string, wherein the traditional design hook only can be placed at the end of the lure.

The hook assembly of the present invention is symmetrical in any position on a wire, shaft, line leader or string, whereas a traditional hook is asymmetrical except when placed at the end of the wire, shaft, line leader or string.

When the lure manufacturer is interested to place more than one hook on the lure, it is necessary to make elaborate bridles and extra wires in order to place two traditional hooks, while the hook of the present invention can easily be placed in multiple arrangements.

Hook of the present invention is more humane to fish due to the fact that it allows hooking the fish properly through the mouth, while a traditional hook can cause a lot of unnecessary damage to the fish.

Hook of the present invention reduces the “line twist” problem thus extending monofilament lifespan and eliminating excess monofilament pollution that kills scores of marine life.

Multiple hooks can be placed in line, which can be useful for deep-sea fishing where hooks can be placed at various depths without extraneous knots and lines hanging out, thus reducing tangles.

The unique design of the present invention will create many new lure-making possibilities and brand new design opportunities for the fishing industry. Whole new line and leader set-ups can be derived from the design of the present invention.

It is known to those skilled in the art that knots on the line reduce the strength of the line by creating weak points; however, the design of the present invention eliminates such a problem. The hook of the present invention can be placed on the line by simply making a stop knot larger than the diameter of the channel or the attachment element without making any weak points.

Thus, it can be seen that the objects of the present invention have been satisfied by the structure presented hereinabove. While in accordance with the Patent Statutes, only the best mode and preferred embodiments of the present invention have been presented and described in detail, it is to be understood that the invention is not limited thereto or thereby. Accordingly, for an appreciation of the true scope and breadth of the invention, references should be made to the following claims.

1. A fishing hook comprising:
a shank portion and
at least one hook portion, said hook portion extending from a lower end of said shank portion,
said shank portion is provided with
a hook attachment means, wherein said hook attachment means is adapted to be threaded onto
a hook support means attached to fishing tackle;
wherein said hook attachment means facilitates free sliding of said fishing hook along said hook support means and
wherein said hook attachment means accommodates said hook support means in substantially parallel relationship to said shank portion.

2. Fishing hook according to claim 1, wherein said hook attachment means is a channel formed along said shank portion.

3. Fishing hook according to claim 2 wherein said channel is formed within a tube extending along said shank portion, said tube is adapted to accommodate said hook support means within said channel.

4. Fishing hook according to claim 3, wherein said tube extends along the entire length of said shank portion.

5. Fishing hook according to claim 3, wherein said tube extends at least ¼ of the length of said shank portion.

6. Fishing hook according to claim 1, wherein said hook attachment means is a number of rings provided to accommodate said hook support means.

7. Fishing hook according to claim 6, wherein said rings are located at an upper end and the lower end of said shank portion.

8. Fishing hook according to claim 6, wherein said rings are spaced along the entire length of said shank portion.

9. Fishing hook according to claim 2, wherein said channel is formed within said shank portion.

10. Fishing hook according to claim 2, wherein said hook is attached to said fishing tackle by means of a leader, wherein said leader is provided with a flexible loop at one end and a stopper at the other end, said loop is adapted to be threaded through said channel and said stopper has a diameter which is larger than the diameter of said channel to facilitate secure support of said hook on said leader.

11. Fishing hook according to claim 1, wherein said hook is a treble hook and wherein each of said treble hooks has the shank portion and the hook portion.

12. Fishing hook according to claim 1, wherein said hook is a quadruple hook.

13. Fishing hook according to claim 5, wherein said tube is attached to said shank portion by means of a welding.

14. Fishing hook according to claim 1, wherein said hook support means is fishing line.

15. Fishing hook according to claim 1, wherein said hook support means is a shaft or a wire of a fishing lure.

16. Fishing hook according to claim 11, wherein said channel is located between said shaft portions.

17. Fishing hook according to claim 11, wherein said channel is located outside along said shaft portions.

18. A fishing hook comprising:
a shank portion and
at least one hook portion, said hook portion extending from a lower end of said shank portion,
said shank portion is provided with
a hook attachment means, wherein said hook attachment means is adapted to be threaded onto
a hook support means attached to fishing tackle;
wherein said hook attachment means facilitates free sliding of said fishing hook along said hook support means;
wherein said hook attachment means accommodates said hook support means in substantially parallel relationship to said shank portion and
wherein said hook attachment means is a channel formed along said shank portion.

19. Fishing hook according to claim 18, wherein said channel is formed within a tube extending along said shank portion, said tube is adapted to accommodate said hook support means within said channel.

20. Fishing hook according to claim 19, wherein said tube extends along the entire length of said shank portion
